(19) United States
(12) Patent Application Publication
(10) Pub. No.: US 2005/0165206 A1
(43) Pub. Date: Jul. 28, 2005

(54) Method for producing melt-stable homo- and copolyesters of cyclic esters and/or diesters

(75) Inventors: Gerald Rafler, Potsdam (DE); Inna Bechthold, Berlin (DE); Horst Riekert, Calw (DE)

Correspondence Address: GUDRUN E. HUCKETT DRAUDT, LONSSTR. 53, WUPPERTAL, 42289, DE

(73) Assignee: FRAUNHOFER-GESELLSCHAFT ZUR FORDERUNG DER ANGEWANDTEN FORSCHUNG E.V., MUNCHEN (DE)

(21) Appl. No.: 10/511,297

(22) PCT Filed: Apr. 11, 2003
(86) PCT No.: PCT/DE03/01241

(30) Foreign Application Priority Data
Apr. 16, 2002 (DE) 102 16 834.2

(51) Int. Cl. C08G 63/02

(52) U.S. Cl. 528/272

(57) ABSTRACT

In a method for producing a homopolyester or copolyester obtainable from at least one cyclic monomer, the at least one cyclic monomer is polymerized in the presence of an initiator. The initiator is selected from organo-tin compounds, tin carboxylates, and tin alkoxides of the oxidation state II or IV that may contain optionally hydroxy groups. At the latest at a point in time when a desired degree of polymerization is reached, a phosphinic acid and/or a phosphinic derivative of the formula (R₁)(R₂)P(═O)X is added, wherein R₁ and R₂ each are independently of one another hydrogen, alkyl, aryl, or hetero aryl, and X is —OR₃ or —NR₁R₂, wherein R₃ is hydrogen, alkyl, aryl, M^{I} or ½M^{II} and M^{I} is an alkali metal ion and M^{II} is an alkaline earth metal ion and wherein the substituents R₁ and R₂ have the meaning indicated above.

The invention relates to a method for producing melt-stable homopolyesters and copolyesters by ring-opening polymerization of the corresponding cyclic monomers, for example, the cyclic diesters of lactic acid, in the presence of an initiator/stabilizer system.

Homopolyesters and copolyesters of L- or D,L-lactic acid can be used in a variety of ways as biologically decomposable polymer materials with typical thermoplastic processing and application properties as packaging plastics, in hygiene products, in disposable articles as well as surgical implant material or galenic additives for parenteral medicament delivery systems. An indispensable prerequisite for use of these homopolyesters or copolyesters in all aforementioned fields of application are constant product properties on the molecular level, such as molecular weight and molecular mass distribution of the homopolyesters and copolyesters, maintaining chiral properties in the case of poly-L-lactic acid, or comonomer ratio and co-monomer distribution in the case of copolyesters. Under technical conditions, this consistency of product properties can be achieved only by means of appropriate safely controllable synthesis methods or by means of efficient additives.

High-molecular polyesters of lactic acid can be produced as a result of the equilibrium constant of the ring/chain equilibrium only by ring-opening polymerization of the cyclic diester of lactic acid (L,L-3,6-dimethyl-1,4-dioxane-2,5-dione or D,L-3,6-dimethyl-1,4-dioxane-2,5-dione, in the following referred to as L,L-dilactide or D,L-dilactide). For initiating or catalyzing this polymerization reaction, preferably organometallic compounds of tin are employed (compare, for example, J. Dahimann, G. Rafler: Acta Polymerica 44 (1993) 103 and the references cited therein). Technical processing proposals, performed as mass polymerization in the melted phase at temperatures of 185-220° C., concern almost exclusively tin-II-octonoate that is said to accelerate especially efficiently the ring-opening polymerization (U.S. Pat. No. 5,484,881). In addition to tin-II-octonoate, often other compounds of divalent or tetravalent tin are described as initiators or catalysts (compare U.S. Pat. No. 5,848,881). However, other metal compounds such as alkoxides of zinc, lead, magnesium, titanium, or zirconium are mentioned in principle as potentially applicable catalytically active substances; however, technical processes based on these initiators or catalysts are not disclosed (S. Jacobson, Ph. Degee, H.-G. Fritz, Ph. Dubois, R. Jerome: Polymer Eng. Sci. 39 (1999) 1311; W. M. Stevels, P. J. Dijkstra, J. Feijen, TRIP 5 (1997) 300.)

The selection of initiators for ring-opening polymerization is determined moreover to a high degree by the substrate to be polymerized. Cyclic monoesters, for example, caprolactone or cyclic carbonates such as 1,3-dioxane-2-one (trimethylene carbonate) are significantly less sensitive with regard to the initiator than, for example, dilactide or 1,4-dioxane-2,5-dione (diglycolide) (G. Rafler, G. Dahlmann: Acta Polymerica 43 (1992) 91; G. Rafler: Acta Polymerica 44 (1993) 168), and they can therefore be polymerized without problems in the presence of the initiators mentioned in U.S. Pat. No. 5,484,881 or in other references (compare, for example, A.-C. Löfgren, A.-C. Alberson, P. Dubois, R. Jerome: Rev. Macromol. Chem. Phys. C. 35 (1995) 379) when the important additional boundary conditions for this polymer formation reaction, such as purity of the monomers, exclusion of water, and minimization of thermal stress, are observed when performing the process.

Tin-containing initiators, preferably tin-II-octonoate, mostly employed according to the prior art, cause with regard to molecular weight of the polymer a reaction profile that is technically difficult to control having: an extremely steep incline at the beginning of the reaction, an undefined molecular weight maximum with regard to its absolute height, and a pronounced decomposition of the polymer after passing through the maximum (compare E. Dahlmann, R. Rafler: Acta Polymerica 44 (1993) 107). This profile of the temporal development of the molecular weight that is unsuitable for a technical process is greatly dependent on concentration wherein, in contrast to ion-initiated and radical-initiated polymerization processes of olefins, conversion and molecular weight, at least for the majority of the tin-initiated polymerizations, are synchronous in ring-opening polymerization, i.e., high polymerization rate and high conversion also lead to high molecular weights. Ring/chain equilibrium and hetero-chain character of the formed polymers determine their molecular properties and thus also theirdeformation and application properties. In particular, the equilibrium character of this special polymerization and the related tendency for back conversion of the cyclic monomer by depolymerization is initiated or activated also by the initiator. This behavior of the initiators therefore not only makes the control of the synthesis process more difficult but also leads to significantly disruptive depolymerizations with corresponding reduction of the molecular weight during the thermoplastic processing of the polymers. The monomer that is converted back leads moreover to a significant faster and uncontrollable hydrolysis of the polymers in the presence of moisture and thus to an undesirable impairment of the utilization possibilities of the polymer.

These undesirable side effects of the technically known polymerization initiators are further enhanced by the “back-biting” reaction that has been described several times and leads to linear or cyclical products of low molecular weight (compare, for example, H. R. Kricheldorf, M. Berl, N. Scharnagl: Macromolecules 21 (1988) 268). Aside from the reversible depolymerization and decomposition processes of these polyesters that are caused by the reaction mechanism, irreversible chain cleavage reactions by thermal decomposition reactions also cannot be precluded. These thermolysis processes lead to unspecific decomposition products that remain within the polymer and, as a function of the degree of this thermolysis, lead to discoloration of the polymer up to the point of forming gel particles. While the reversible depolymerization with back conversion of the monomer or the comonomer is a function of the initiator type, initiator concentration, and process temperature, the thermal decomposition is determined almost exclusively by the temperature.

The repression of the cyclical depolymerization during treating and processing is efficiently realized in the case of polyesters that are prepared in the presence of tin, titanium or zirconium initiators by chemical masking of the initiator by means of complex forming agents. In the case of tin components, tropolone and its derivatives (DE patent 195 37 365, U.S. Pat. No. 5,760,119) are particularly suitable. The technical realization of this method however poses difficulties because these complex forming agents are available only to a limited extent and they impair only the direct depolymerization. Thermally initiated unspecific decomposition processes are not impaired or delayed by tropolone compounds.

Unspecific thermal-oxidative and hydrolytic decomposition reactions, preferably during the deformation of these aliphatic polyesters, are inhibited by water-binding additives (hydrolysis), such as carbodiimide, activated acid derivatives or isocyanates (compare, for example, U.S. Pat. No. 6,005,068). For inhibiting the decomposition, in U.S. Pat. No. 6,005,068 the well-known phosphites (for example, Ultranox RTM 626) and sterically hindered phenols are employed as antioxidants, wherein preferably the commercially available IRGANOX types are mentioned. The ring-opening polymerization is said to occur faster in the presence of these antioxidants, and significantly higher molecular weights are said to be obtained, as demonstrated with the aid of example 13. Moreover, the polymer during extraction of monomers in vacuum is said to be stabilized with respect to decomposition reactions, as demonstrated in example 11. However, the back conversion of monomer during processing of the polymerized compound cannot be achieved in this way: The addition of radical scavengers such as Irganox or Ultranox during remelting of already polymerized samples from which the monomer has been extracted results in renewed formation of monomers (see Table 13 in comparison to Table 12 of U.S. Pat. No. 6,005,068).

Initiator combinations based on organo-tin and organo-titanium compounds that interact differently in ring-opening polymerization and cyclizing depolymerization work in very different ways in regard to reaction mechanism but with relatively good effect. In the presence of such initiator combinations, the depolymerization can be repressed under mass polymerization conditions, the extremum character of the polymerization profile can be largely overcome, and the method can be made safer in this way (compare DE 101 13 302.2).

In view of the initiator-caused difficulties of the technical controllability of the ring-opening polymerization, the unsatisfactory constancy of the product properties of polyesters synthesized in this way, as well as the unsatisfactory melt stability, it is the object of this invention to propose additives and methods that enable the discontinuous or continuous production in differently designed facilities of melt-stable homopolyesters and copolyesters that can be polymerized starting from cyclical esters of the L-lactic acid and D,L-lactic acid and other cyclical monomers, in particular, additional cyclical esters, and that enble their processing without back conversion of monomer. Preferably, molecularly especially uniform products are to be produced independent of the polymerization conditions.

According to the invention, it is proposed that the ring-opening polymerization is carried out in the presence of known organo-tin initiators, optionally in the presence of additional initiators and/or stabilizers on the basis of metals of the group IV of the transition metals, in particular, based on titanium or zirconium. For preventing back conversion of monomer and thermolysis, reducing agents that suppress the reversability of the conversion largely or completely are used optionally already during manufacture, particularly preferably when, or shortly before, the desired degree of polymerization is reached, primarily however in a subsequent thermoplastic forming step. These substances are organo-phosphorus additives with low oxidation state of the phosphorus, in particular, phosphorus additives on the basis of phosphinic acid, its salts, or esters or amides of the general formula (I)
(R₁)(R₂)P(═O)X (I)
wherein R₁ and R₂ each are independently of one another hydrogen, alkyl, aryl, or hetero aryl, and X is —OR₃ or —NR₁R₂, wherein R₃ is hydrogen, alkyl, aryl, M^{I} or ½ M^{II} and M^{I} is an alkali metal ion and M^{II} is an alkaline earth metal ion and the substituents R₁ and R₂ have the meaning indicated above.

According to the invention, the substituents R₂ and R₃ or the substituents R₁ and R₂ together with the phosphorus and optionally together with the nitrogen atom or oxygen atom can also form a saturated or unsaturated heterocyclic compound, for example,

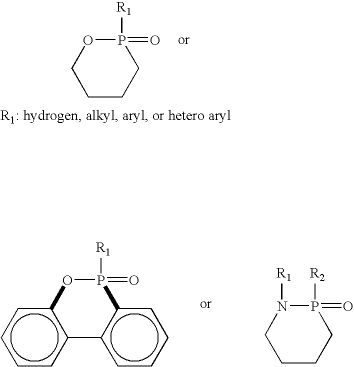

For the polymerization and stabilization process according to the invention in principle all cyclic starting compounds are suitable that can be polymerized to polyesters under the effect of tin-containing polymerization catalysts or initiators.

They can be, for example, cyclic esters, in particular, monoesters or diesters such as dilactide or caprolactone. With regard to their chemical structure, their number and their quantitative ratios, they can be used as desired and can optionally contain additional components.

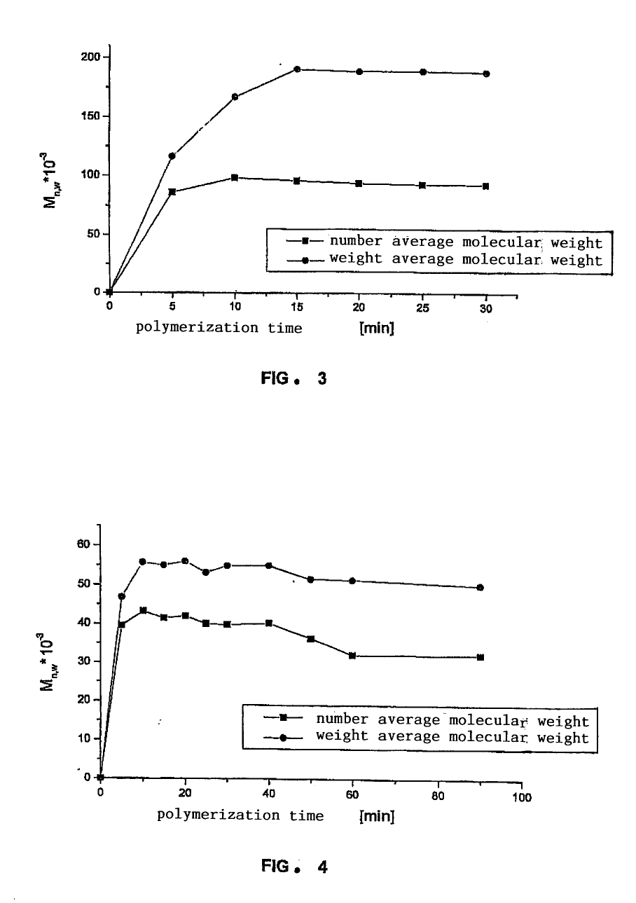

The method according to the invention enables not only a safe control of the ring-opening polymerization by means of the adjustability of a stable molecular weight level (compare Example 3 and FIG. 3) but also leads to a polymer of higher thermal stability under the production and processing conditions and defined narrow polydispersity (expressed by the ratio of weight average molecular weight and number average molecular weight M_{w}/Mₙ). The tin-II-octonoate (Sn(oct)₂) typical reaction profiles that are reproducible only with difficulty under technical conditions and have a pronounced extremum character for the temporal change of the molecular weight (compare Example 2 and FIG. 2) as well as the back conversion of disruptive monomers as a result of thermal stress during treatment and thermoplastic forming are prevented when employing the initiator/stabilizer system according to the invention.

The average molecular weights of the polymers in the listed Examples 2-11 were determined by gel chromatography in tetrahydrofurane on extracted and dried polymer samples. The separation by gel-chromatography is carried out on Styragel with simultaneous determination of concentration (refractive index) and molecular weight (scattered light photometry) of the individual polymer fractions. In this way, a very precise direct molecular weight determination is possible that is decidedly superior in comparison to the frequently still employed methods using calibration substances of known molecular weight for calibrating the methodology or in comparison to relative methods such as measuring solution viscosity. The simultaneous determination of both average values of the molecularweight enables also a very precise determination of the molecular non-uniformness of the polymers based on the quotient of both average values of the molecular weight (M_{w}/Mₙ in Table 2). The molecular non-uniformness is a significant product parameter for a polymer material because, in addition to the molecular weight, it determines decisively the application-relevant polymer properties on a molecular level. The deformation and material properties of a plastic material result from the combination of these polymer properties and the morphological properties of the solid polymer body. In this connection, the superiority of the method according to the invention in comparison to the known prior art is also demonstrated. Not only the technological controllability of the ring-opening polymerization is improved significantly but also molecularly uniform products are obtained independent of the process duration.

The stabilization of the polyester prevents not only the equilibrium-caused depolymerization (prevention of the extremum character in M_{w},ₙ=f(t)) and the exchange between chains (M_{w}/Mₙ=f(t)) under synthesis conditions but it minimizes also the disturbing monomer back conversion during the thermoplastic processing of these aliphatic polyesters (see Table 3 in Example 11).

The stabilization of the molecular weight in accordance with the present invention by organo-phosphorus additives based on phosphinates can be employed for discontinuous manufacture, for example, in agitator reactors or kneaders, as well as for continuous processes in vertical or horizontal reactors. Particularly efficient are reactive extrusion methods performed in double-screw extruders with screws rotating in the same direction; metering of the melt stabilizer can be realized in a particularly simple way and, moreover, the homogenous distribution of the additives in the highly viscous polyester melt does not present any difficulties. In the discontinuous production, the additive is preferably admixed at a point in time when the reaction has reached the desired conversion rate. In the case of continuous manufacture, the additive is preferably added at a location where the polymer is at a point just before leaving the reactor, for example, at a short distance upstream of the removal zone of a (screw) extruder.

Independent of the process concept or type of device, the additives according to the invention can be metered directly as a pure substance, in solution, or in the form of a master batch with the polymer or even the monomers.

According to the invention, the initiator/stabilizer system is used also for the synthesis of statistical and non-statistical binary or ternary copolymers by ring-opening polymerization. This statistic copolyesters are produced in this connection by simultaneous addition (discontinuous) or metering (continuous) of the monomeric esters or diester. Non-statistic copolyesters are obtained by step-wise comonomer addition or preferably by reactive compounding of the homopolyesters in reactors of high mixing intensity such as kneaders or double-screw extruders.

As a result of the homogenous kinetic character of the ring-opening polymerization of the cyclic esters and diesters, the selection of the initiators is determined primarily as a result of their solubility in the monomer melt or polymer melt as well as their compatibility with the selected melt stabilizer. Suitable tin compounds for the initiator/stabilizer systems are, for example, tin-II-carboxylates, tin-IV-alkoxides, dialkoxy tin oxides, trialkoxy tin hydroxides, as well as tin-IV-aryls. It is also possible to employ initiator combinations of tin compounds with titanium compounds or zirconium compounds that are organo-soluble. For this combination, alkoxides of titanium and zirconium are suitable, for example, titanium-IV-acetylacetonate, zirconium octonoate, or zirconium acetylacetonate.

The concentration of the initiator/stabilizer system according to the invention can be selected freely within wide limits wherein however the stabilizer must be used at least in equimolar amounts relative to the initiator. In other respects, the concentration of initiator and stabilizer depends primarily on the technological requirements of the device as well as the material requirements determined by the application, preferably material and forming properties that are determined primarily by the molecular weight and its distribution. The preferred concentration range for the polymerization initiator is at 10⁻⁵-10⁻³ mol/mol monomer unit; the stabilizer is used in a ratio stabilizer/initiator of 2:1 to 10:1 preferably in concentrations of 0.01-0.1% by weight.

Above the melting temperature of the polymer, the polymerization temperature is also variable within a relatively wide range. Without causing disturbing decomposition reactions, temperatures of 180° C.-225° C. can be selected for the polymerization of the L,L-dilactide Forthe polymerization of the D,L-dilactide, lower polymerization temperatures, starting at 125° C., can be used as a result of the lower softening temperature. Also, for the polymerization of other cyclic esters such as caprolactone, 1,3-dioxane-2-one (trimethylene carbonate), 1,4-dioxane-2,5-dione (diglycolide) or 1,4-dioxane-2-one (glycol ester of acetic acid), the reaction temperatures can be selected freely within a wide range above polymerization temperature in the presence of the initiator/stabilizer system of the present invention. Recommended polymerization temperatures are for: caprolactone 130° C.-200° C., 1.3-dioxane-2-one 130° C.-200° C., 1,4-dioxane-2,5-dione 225° C.-250° C., and for 1,4-dioxane-2-one 120° C.-180° C.

In the following, the invention will be explained in more detail based on examples.

### EXAMPLES

### Example 1

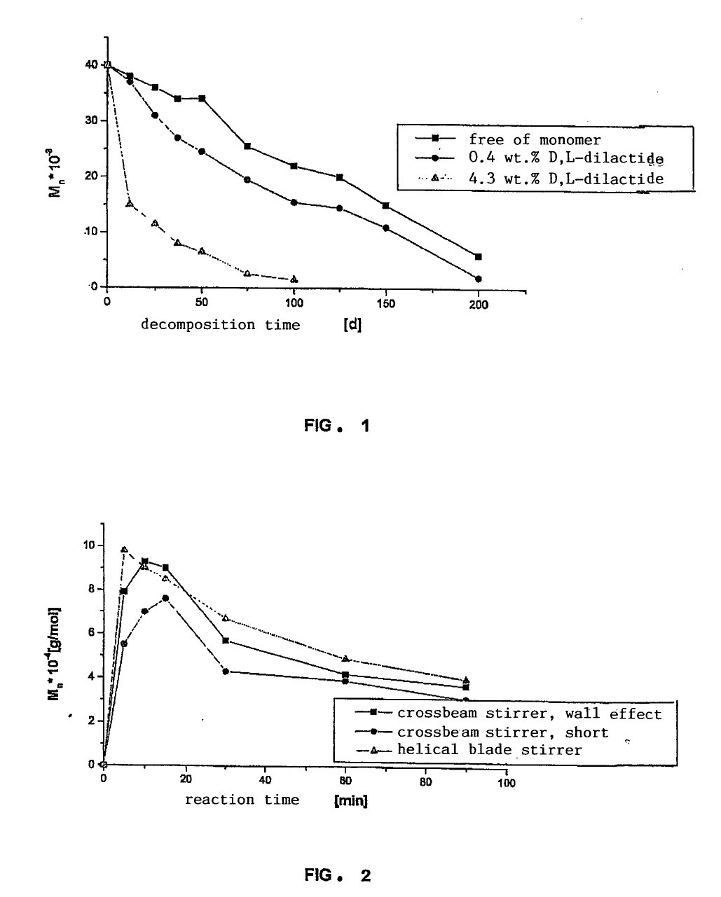

The model examinations regarding the decomposition behavior of polylactides were carried out in aqueous phase. For this purpose, pressed sample bodies having dimensions of 10×10×1 mm were stored in a phosphate-buffered solution and, after different times, gravimetrically the weight and, based on gel chromatography, the molecular weight of these samples were determined after drying. The determination of the monomer contents was realized in the case of the poly-D,L-lactides by recrystallization from dimethyl formamide/methanol and in the case of the poly-L-lactides by extraction with methanol. FIG. 1 shows the in vitro decomposition of poly-D,L-lactides as a function of the monomer contents at 37° C.

The rate of hydrolytic decomposition of amorphous poly-L-lactide obtained from the melt by quenching corresponds to that of the racemic compound (Table 1).

TABLE 1
Rate constants of the hydrolytic decomposition of amorphous
poly-L-lactide and poly-D,L-lactides (in vitro conditions).

| polylactide | k × 10³ [d⁻¹] |
|---|---|
| L | 3.5 |
| D, L | 3.1 |

### Example 2

### Comparative Examples Without Melt Stabilizer With Different Agitators

L,L-dilactide (0.5 mol; 72 g) purified by recrystallization and thoroughly dried is melted in a cylindrical glass reactor with a crossbeam stirrer or screw agitator in inert gas atmosphere. To the stirred monomer melt, the initiator Sn(oct)₂ in the form of an 0.1% solution in toluene is added when the desired temperature is reached. Samples are taken from the polymerizing melt for determining the course of polymerization, of which samples, after appropriate sample preparation by extraction or recrystallization, the weight (for the monomer conversion) and molecular weight are determined. The extraction is realized with methanol in a Soxhlet apparatus; for recrystallization the sample is dissolved in dimethyl formamide and the polymer is precipitated in methanol. The dried polymer samples are used to determine conversion (gravimetrically) and molecular weight (by gel chromatography). FIG. 2 shows the polymerization of L,L-dilactide in the presence of 7.5×10⁻⁵ mol/mol Sn(oct)₂. The illustrated molecular weight/time courses for the polymerization of the L,L-dilactide as a function of mixing are obtained.

### Example 3

L,L-dilactide (0.5 mol; 72 g) purified by recrystallization and thoroughly dried is melted in a cylindrical glass reactor with a screw agitator in inert gas atmosphere and polymerized and treated in analogy to Example 2. The polymerization is carried out in the presence of 7.5×10⁻⁵ mol/mol Sn(oct)₂ as initiator, and 0.01% 9,10-dihydro-9-oxa-10-phosphaphenanthrene-10-oxide (UKANOL DOP) is added as soon as the desired polymerization degree has been approximately reached. Mixing is realized in a screw agitator at 195° C. The course of polymerization illustrated in FIG. 3 is observed.

### Example 4

In analogy to Example 3, L,L-dilactide in the presence of 5×10⁻⁵ mol/mol Sn(oct)₂ is polymerized at 195° C., and 0.01% by weight 9,10-dihydro-9-oxa-10-phosphaphenanthrene-10-oxide is added. The course at reduced initiator concentration is illustrated in FIG. 4. Stabilized poly-L-lactide has a high molecular uniformness, as illustrated in Table 2.

TABLE 2
Polydispersity of melt-stable poly-L-lactides as a function of the
polymerization duration

| time [min] | Mₙ | M_{w} | M_{w}/Mₙ |
|---|---|---|---|
| 10 | 43,200 | 55,600 | 1.3 |
| 20 | 42,000 | 56,500 | 1.3 |
| 30 | 39,900 | 53,800 | 1.4 |
| 60 | 32,100 | 51,400 | 1.6 |
| 90 | 32,200 | 50,700 | 1.6 |

### Example 5

D,L-dilactide (0.5 mol; 72 g) purified by recrystallization and thoroughly dried is melted in a cylindrical glass reactor with a screw agitator in inert gas atmosphere and polymerized and treated in analogy to Example 3. The polymerization is carried out in the presence of 7.5×10⁻⁵ mol/mol Sn(oct)₂ as initiator and 0.01% by weight 9,10-dihydro-9-oxa-10-phosphaphenanthrene-10-oxide (UKANOL DOP). Processing of the polymer samples is realized by recrystallization from dimethyl formamide/methanol. After a polymerization duration of 20 minutes poly-D,L-lactide is obtained having a number-average molecular weight Mₙ=98,000 g/mol at a polydispersity of M_{w}/Mₙ=2.0.

### Example 6

L,L-dilactide (50 mol, 3600 g) purified by recrystallization and thoroughly dried is melted in a horizontal kneader with discharge screw in inert gas atmosphere. For following the course of polymerization, the kneader is provided with a torque measuring device. When the desired temperature of 195° C. is reached, the initiator in the form of Sn(oct)₂ (5×10⁻⁵ mol/mol in the form of an 0.1% solution in toluene) is added, and, after lapse of an additional 7.5 minutes, 0.36 g of the melt stabilizer 9,10-dihydro-9-oxa-10-phosphaphenanthrene-10-oxide (UKANOL DOP) is added to the mixed monomer melt. The melt is intensively mixed in a closed system at 195° C. in the kneader for 25 minutes. After completion of polymerization, the polymer melt is discharged by means of the screw, cooled on a transport belt by blowing cold airthereon, and is made into granules by means of a strand granulator. The polymer granules are extracted with methanol and subsequently dried in vacuum. After treatment of the samples, 3350 g poly-L-lactide having a number-average molecular weight of 85,000 g/mol, a melting point of 174° C., and optical rotation of [α]²⁰=−156.2° are obtained.

### Example 7

L,L-dilactide (1000 g) purified by distillation and thoroughly tried is premixed with 0.15 g Sn(oct)₂ and supplied under exclusion of moisture and air to a twin-screw extruder (type Leistritz Micro 18) having a high proportion of kneading elements for variably combinable screws (transport elements/kneading elements=4/1; L/D=35; 7 heating zones). The melt stabilizer 9,10-dihydro-9-oxa-10-phosphaphenanthrene-10-oxide (UKANOL DOP) is supplied continuously to the polymer melt upstream of the discharge zone of the extruder. For a temperature profile that is adjusted by means of the extruder, beginning at 100° C. at the extruder inlet, 190° C. in the central zones, and 180° C. at the exit, and a rotary speed of 100 min⁻¹ the average residence time of the polymerizing lactide melt in the extruder is approximately 10 minutes. The polymer melt is cooled on a transport belt by blowing cold air thereon and is made into granules by means of a strand granulator. The polymer granules are extracted with methanol and subsequently dried in vacuum. The poly-L-lactide obtained continuously by reactive extrusion has an average molecular weight of Mₙ=93,000 g/mol. The yield is 96.5%.

### Example 8

In analogy to Example 3, L,L-dilactide (72 g, 0.5 mol) purified by recrystallization and thoroughly dried is melted in a cylindrical glass reactor with screw agitator under inert gas atmosphere. To the agitated monomer melt, 0.08 g (10⁻⁴ mol/mol) of a reaction product of dibutyl tin oxide (0.1 V), titanium tetrabutylate (0.2 mol) and n-butanol (0.2 mol) as well as 0.0216 g (2×10⁻⁴ mol/mol) 9,10-dihydro-9-oxa-10-phosphaphenanthrene-10-oxide are added when the desired temperature of 200° C. is reached. After 20 minutes, the polymerization is stopped by cooling and the polymer material is post-treated by extraction with methanol for removing monomers and by vacuum drying. The yield is 65 g poly-L-lactide having an average molecular weight Mₙ=95,000 g/mol.

### Example 9

L,L-dilactide (72 g, 0.5 mol) purified by recrystallization and thoroughly dried is polymerized and processed In analogy to Example 8. The stabilization of the melt is realized however by 0.0332 g (2×10⁻⁴ mol/mol) 2-methyl-2-(9,10-dihydro-9-oxa-10-phosphaphenanthrene-10-oxide) succinic acid. The yield is 68 g poly-L-lactide having an average molecular weight Mₙ=89,000 g/mol.

### Example 10

L,L-dilactide (2,700 g) purified by recrystallization and thoroughly dried is melted together with 1,425 g caprolactone (total amount: 50 mol) in a horizontal kneader with discharge screw in an inert gas atmosphere. To the mixed monomer melt, 1.515 g (7.5×10⁻⁵ mol/mol) Sn(oct)₂ in the form of a 0.1% solution in toluene and, after lapse of additional 5 minutes, 0.4125 g 9,10-dihydro-9-oxa-10-phosphaphenanthrene-10-oxide are added when the desired temperature of 175° C. is reached. The melt is mixed intensively in a closed system at 175° C. in the kneader for 45 minutes. The poly(L-lactide(75)-co-caprolactone(25)) is recrystallized from dimethyl formamide/water for removing the monomer. After drying at 80° C. in vacuum, 3700 g copolymer with an average molecular weight of 112,000 g/mol is obtained.

### Example 11

Melt-stabilized polylactide produced in accordance with Examples 3-9 is extracted exhaustively with methanol and after drying to constant weight (residual moisture<0.02 percent) is processed in an injection molding machine (type ARBURG Allrounder 270 M) to test specimens (dogbone-shaped specimen, ISO specimen). The back-converted monomer in the test specimens is determined gravimetrically by extraction with methanol (Table 3).

TABLE 3
Extract contents of melt-stabilized poly-L-lactides before and after
forming by injection molding

| forming | extract [%] |
|---|---|
| before | 0.22 |
| after | 0.24 |

1.-15. (canceled)

16. A method for producing a homopolyester or copolyester obtainable from at least one cyclic monomer, the method comprising the steps of:
polymerizing at least one cyclic monomer in the presence of an initiator, wherein the initiator is selected from the group consisting of organo-tin compounds, tin carboxylates, and tin alkoxides of the oxidation state II or IV that may contain optionally hydroxy groups;
adding at the latest at a point in time when a desired degree of polymerization is reached, a phosphinic acid and/or a phosphinic derivative of the formula (I)
(R₁)(R₂)P(═O)X (I)
wherein R₁ and R₂ each are independently of one another hydrogen, alkyl, aryl, or hetero aryl, and X is —OR₃or —NR₁R₂, wherein R₃ is hydrogen, alkyl, aryl, M^{I} or ½M^{II} and M^{I} is an alkali metal ion and M^{II} is an alkaline earth metal ion and wherein the substituents R₁ and R₂ have the meaning indicated above.

17. The method according to claim 16, wherein, in the step of polymerizing, organo-soluble metal compounds of the group IV of the transition metals are present.

18. The method according to claim 17, wherein the organo-soluble metal compounds are selected from the group consisting of titanium compounds and zirconium compounds.

19. The method according to claim 16, wherein the substituents R₂ and R₃ or the substituents R₁ and R₂ of the formula (I) together with the phosphorus and optionally togetherwith the nitrogen atom or oxygen atom form a saturated or unsaturated heterocyclic compound.

20. The method according to claim 19, wherein the formula (I) has the following meaning:

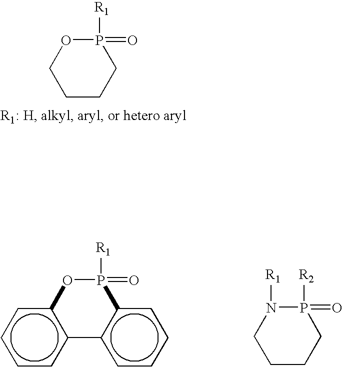

21. The method according to claim 16, wherein a molar ratio of the initiator to the phosphinic acid and/or the phosphinic derivative of the formula (I) is 1:1 to 10:1.

22. The method according to claim 21, wherein the molar ratio is approximately 2:1.

23. The method according to claim 16, wherein the phosphinic acid and/or the phosphinic derivative of the formula (I) is selected from the group consisting of alky phosphinic acid, dialkyl phosphinic acid, aryl phosphinic acid, diaryl phosphinic acid, and alkyl aryl phosphinic acid.

24. The method according to claim 23, wherein the aryl phosphinic acid ester is 9,10-dihydro-9-oxa-10-phosphaphenanthrene-10-oxide and wherein the alkyl aryl phosphinic acid ester is 2-methyl-2-(9,10-dihydro-9-oxa-10-phosphaphenanthrene-10-oxide) succinic acid.

25. The method according to claim 16, wherein the at least one cyclic monomer is selected from the group consisting of cyclic esters and cyclic diesters and mixtures of the cyclic esters and the cyclic diesters.

26. The method according to claim 25, wherein the cyclic esters are selected from the group consisting of ε-caprolactone, 1,3-dioxane-2-one, and 1,4-dioxane-2-one, and wherein the cyclic diesters are selected from the group consisting of 1,4-dioxane-2,5-dione, L,L-3,6-dimethyl-1,4-dioxane-2,5-dione, D,L-3,6-dimethyl-1,4-dioxane-2,5-dione, and meso-3,6-dimethyl-1,4-dioxane-2,5-dione.

27. The method according to claim 16, wherein the phosphinic acid and/or the phosphinic derivative of the formula (I) is added at a time when the polymerization reaction is essentially completed.

28. The method according to claim 16, wherein the phosphinic acid and/or the phosphinic derivative of the formula (I) is added as a pure substance, in solution or as a master batch.

29. The method according to claim 16, performed continuously in an extruder, wherein the phosphinic acid and/or the phosphinic derivative of the formula (I) is fed into the extruder at a short distance upstream of a discharge zone of the extruder.

30. A method for stabilizing a melt of a homopolyester or copolyester obtainable from at least one cyclic monomer, wherein the at least one cyclic monomer is polymerized in the presence of an initiator, selected from the group consisting of organo-tin compounds, tin carboxylates, and tin alkoxides of the oxidation state II or IV that may contain optionally also hydroxy groups, and optionally in the presence of organo-soluble metal compounds of the group IV of the transition metals; the method comprising the step of:
adding to a melt of a homopolyester or copolyester a phosphinic acid and/or a phosphinic derivative of the formula (I)
(R₁)(R₂)P(═O)X (I)
wherein R₁ and R₂ each are independently of one another hydrogen, alkyl, aryl, or hetero aryl, and X is —OR₃ or —NR₁R₂, wherein R₃ is hydrogen, alkyl, aryl, M^{I} or ½M^{II} and M^{I} is an alkali metal ion and M^{II} is an alkaline earth metal ion and the substituents R₁ and R₂ have the meaning indicated above.

31. The method according to claim 30, wherein the substituents R₂ and R₃ or the substituents R₁ and R₂ of the formula (I) together with the phosphorus and optionally together with the nitrogen atom or the oxygen atom form a saturated or unsaturated heterocyclic compound.

32. The method according to claim 32, wherein the formula (I) has the following meaning:

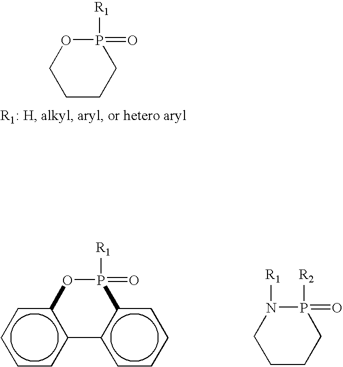

33. The method according to claim 30, wherein a molar ratio of the initiator to the phosphinic acid and/or the phosphinic derivative of the formula (I) is 1:1 to 10:1.

34. The method according to claim 33, wherein the molar ratio is approximately 2:1.

35. The method according to claim 30, wherein the phosphinic acid and/or the phosphinic derivative of the formula (I) is selected from the group consisting of alky phosphinic acid, dialkyl phosphinic acids aryl phosphinic acid, diaryl phosphinic acid, and alkyl aryl phosphinic acid.

36. The method according to claim 35, wherein the aryl phosphinic acid ester is 9,10-dihydro-9-oxa-10-phosphaphenanthrene-10-oxide and wherein the alkyl aryl phosphinic acid ester is 2-methyl-2-(9,10-dihydro-9-oxa-10-phosphaphenanthrene-10-oxide) succinic acid.

37. The method according to claim 30, wherein the at least one cyclic monomer is selected from the group consisting of cyclic esters and cyclic diesters and mixtures of the cyclic esters and the cyclic diesters.

38. The method according to claim 37, wherein the cyclic esters are selected from the group consisting of &-caprolactone, 1,3-dioxane-2-one, and 1,4-dioxane-2-one, and wherein the cyclic diesters are selected from the group consisting of 1,4-dioxane-2,5-dione, L,L-3,6-dimethyl-1,4-dioxane-2,5-dione, D,L-3,6-dimethyl-1,4-dioxane-2,5-dione, and meso-3,6-dimethyl-1,4-dioxane-2,5-dione.
